(19) United States
(12) Patent Application Publication
(10) Pub. No.: US 2009/0181216 A1
(43) Pub. Date: Jul. 16, 2009

(54) Roofing Membranes Including Fluoropolymer

(76) Inventor: Lichih R. Peng, Fishers, IN (US)

Correspondence Address: Renner,Kenner, Greive, Bobak, Taylor & Weber, Fourth Floor, First National Tower, Akron, OH, 44308, US

(21) Appl. No.: 12/224,111

(22) PCT Filed: Feb. 16, 2007
(86) PCT No.: PCT/US07/04071

§ 371 Date: Dec. 4, 2008

Related U.S. Application Data
(60) Provisional application No. 60/774,349, filed on Feb. 17, 2006.

(51) Int. Cl. B32B 27/00; D03D 9/00; C08F 214/18

(52) U.S. Cl. 428/192; 428/421; 442/1; 428/332; 526/242

(57) ABSTRACT

A membrane comprising at least two distinct polymeric layers, where one layer includes a fluorine-containing polymer.

This application is a §371 application of PCT/2007/004071 filed Feb. 16, 2007, which claims the benefit of U.S. Provisional Application No. 60/774,349, filed Feb. 17, 2006, which are incorporated herein by reference.

### FIELD OF THE INVENTION

One or more embodiments of the present invention are directed toward thermoplastic roofing membranes and covered roofs including the same, where the roofing membrane includes a fluoropolymer layer.

### BACKGROUND OF THE INVENTION

Flat or low-slope roofs are often covered with multi-layered roofing systems. These roofing systems often include a roof deck, an optional insulation layer, and a protective, weather-resistant membrane. In some situations, a coverboard is also employed. In many situations, insulation boards are typically adhered directly to a roof deck, which is most commonly constructed of concrete or steel. The insulation boards are then covered with the weather resistant membrane, commonly known as “roofing membranes.”

The roofing membranes may include large, flexible sheets that are delivered to a construction site in a bundled roll, transferred to the roof, and then unrolled and laid flat. The sheets are then affixed to the building structure by employing varying techniques such as mechanical fastening, ballasting, and/or adhering the membrane to the roof deck or insulation layer. The roofing membranes are employed for their weather resistance, because the roofs on which they are employed are typically exposed to the local weather conditions.

Because roofing membranes must often endure extreme environmental conditions, there is a desire to improve the environmental resistance of the membranes. This, however, is not a trivial because any alterations made to the membrane can have a deleterious impact on the other performance characteristics of the membrane such as the mechanical properties of the membranes.

### SUMMARY OF THE INVENTION

One or more embodiments of the present invention provide a membrane including at least two distinct polymeric layers, where one layer includes a fluorine-containing polymer.

Other embodiments of the present invention provide a multi-layered thermoplastic membrane including a first layer including a thermoplastic fluorine-containing polymer and a second layer that is distinct from the first layer.

Other embodiments of the present invention provide a membrane including a coating, the membrane including a membrane substrate and a coating disposed on the substrate, where the coating includes a fluorine-containing polymer.

Other embodiments of the present invention provide a method of treating a roofing membrane, the method comprising coating the roofing membrane with a composition including a fluorine-containing polymer.

Other embodiments of the present invention provide a co-extruded membrane comprising at least one cast film that includes a fluorine-containing thermoplastic polymer.

Other embodiments of the present invention provide a polymeric membrane coated with a composition including a fluorine-containing polymer.

Other embodiments of the present invention provide a polymeric membrane substantially as hereinbefore described with reference to any one of FIGS. 1 to 8.

### BRIEF DESCRIPTION OF THE DRAWINGS

FIG. 1A is a perspective view of a longitudinal and lateral cross-section of a roofing membrane according to one or more embodiments of the present invention.

FIG. 1B is a perspective view of the membrane of FIG. 1A with various components shown in exploded view.

FIG. 2 is a perspective view of a longitudinal and lateral cross-section of a three-layered roofing membrane according to one or more embodiments of the present invention.

FIG. 3 is a perspective view of a longitudinal and lateral cross-section of a four-layered roofing membrane shown in break away view according to one or more embodiments of the present invention.

FIG. 4 is a perspective view of a longitudinal and lateral cross-section of a five-layered roofing membrane including a tie layer shown in break away view according to one or more embodiments of the present invention.

FIGS. 5A and 5B are cross-sectional view of portions of membranes including gum edges according to two different embodiments.

FIG. 6 is a perspective view of a lateral cross-section of a roofing membrane according to one or more embodiments of the present invention.

FIG. 6A is a cross-sectional view of a portion of the membrane shown in FIG. 6 showing the weld edge present along a longitudinal edge of the membrane according to one or more embodiments of the present invention.

FIG. 7 is a perspective view of a longitudinal and lateral cross-section of a roofing membrane where the membrane includes a coating layer according to one or more embodiments of the present invention.

FIG. 8 is a perspective view of a lateral and longitudinal cross-section of a roofing system including a deck, insulation layer, and membrane according to one or more embodiments of the present invention.

### DETAILED DESCRIPTION OF ILLUSTRATIVE EMBODIMENTS

One or more embodiments of the present invention are directed toward multi-layered thermoplastic roofing membranes where at least one layer of the membrane includes a fluorine-containing polymer, which may also be referred to as a fluoropolymer. These membranes may be useful in roofing systems for covering and/or protecting flat or sloped roofs (e.g., high-sloped roofs and low-sloped roofs). In one or more embodiments, the laminate membranes include those meeting at least one of the specifications set for in ASTM D4637-03, ASTM D6878-03, ASTM D1418-85. In a first set of embodiments, the layer including the fluoropolymer may be a thermoplastic layer, and the fluoropolymer contained therein may be a thermoplastic polymer. In a second set of embodiments, the layer including the fluoropolymer may a thermoset layer, such as one formed from a coating composition.

The following describes those embodiments where the layer containing the fluoropolymer is a thermoplastic layer. In one or more embodiments, the membranes include at least one layer including a fluorine-containing polymer and at least one layer that includes no or only a limited amount of fluorine-containing polymer. In one or more embodiments, the layer including no or only limited fluorine-containing polymer is devoid or substantially devoid of fluorine-containing polymer. Substantially devoid refers to that amount or less of fluorine-containing polymer that will not have an appreciable impact on the properties of the layer. In one or more embodiments, this layer includes less than 5 weight %, in other embodiments less than 2 weight %, in other embodiments less than 1 weight %, in other embodiments less than 0.5 weight %, and in other embodiments less than 0.1 weight % fluorine-containing polymer. For ease of explanation throughout the written description, the layer including no or only limited amounts of fluorine-containing polymer may be simply referred to as the layer that is substantially devoid of fluorine-containing polymer or substantially devoid of fluoropolymer.

In one or more embodiments, the layer substantially devoid of fluoropolymer may be characterized by a 1% secant modulus, as determined according to ASTM D-7908, of at least 60 megapascals (mPa), in other embodiments at least 70 mPa, in other embodiments at least 75 mPa, and in other embodiments at least 80 mPa. In these or other embodiments, the 1% secant modulus is less than 200 mPa, in other embodiments less than 150 mPa, and in other embodiments less than 120 mPa.

In one or more embodiments, the layer including the fluorine-containing polymer includes at least 10 weight %, in other embodiments at least 25 weight %, in other embodiments at least 50 weight %, in other embodiments at least 75 weight %, in other embodiments at least 90 weight %, and in other embodiments at least 99 weight % of a fluoropolymer, based upon the total weight of the polymeric content of the layer. In particular embodiments, substantially all of the polymeric content of the layer includes fluorine-containing polymer. In certain embodiments, 100 weight % of the polymeric content of the layer includes fluoropolymer.

In one or more embodiments, the individual layers of the membrane may be secured or fixedly attached to adjacent layers. This may be achieved by employing known techniques for laminating individual layers including calendaring or heat laminating. In particular embodiments, a tie layer is positioned or disposed between the layer including the fluoropolymer and the at least one layer substantially devoid of fluoropolymer. In one or more embodiments, the layer adjacent to the layer including a fluorine-containing polymer is a tie layer including a material that is capable of increasing the bond strength of the adjacent layers, particularly between one layer including a fluoropolymer and another layer that is substantially devoid of fluoropolymer.

In one or more embodiments, the layer including the fluorine-containing polymer may be positioned at the top of the membrane, which includes the planar surface of the membrane exposed to the elements when positioned on a roof. The layer substantially devoid of fluoropolymer may be positioned internally or at the bottom of the membrane, which includes the planar surface of the membrane nearest the roof deck when positioned on a roof.

In addition to the layer including the fluorine-containing polymer and the layer substantially devoid of fluoropolymer, the membranes of the present invention may also include other polymeric layers. Also, the membranes may include a reinforcing fabric such as reinforcing scrim.

In one or more embodiments, the thickness of the membrane of the present invention (including each of the layers) may be from about 0.5 to about 2.5 mm, in other embodiments from about 1.0 to about 2.0 mm, and in other embodiments from about 1.2 to about 1.7 mm.

In one or more embodiments, the thickness of the layer including the fluorine-containing polymer may be from about 0.05 to about 3 mm, in other embodiments from about 0.075 to about 1 mm, in other embodiments from about 0.09 to about 0.5 mm, and in other embodiments from about 0.1 to about 0.3 mm. In these or other embodiments, the thickness of the layer may be less than 0.375 mm, in other embodiments less than 0.300 mm, and in other embodiments less than 0.27 mm; in these or other embodiments, the thickness of the layer including the fluoropolymer may be at least 0.125 mm, in other embodiments at least 0.15 mm, and in other embodiments at least 0.17 mm.

In one or more embodiments, the thickness of at least one of the other layers that is substantially devoid of fluorine-containing polymer (e.g. inner-layer 22) may be from about 0.05 to about 1 mm, in other embodiments from about 0.075 to about 0.5 mm, and in other embodiments from about 0.1 to about 0.3 mm.

In one or more embodiments, the scrim is positioned in the center of the membrane. In other words, the thickness of the layers above the scrim is the same or substantially the same as the thickness of the layers below the scrim.

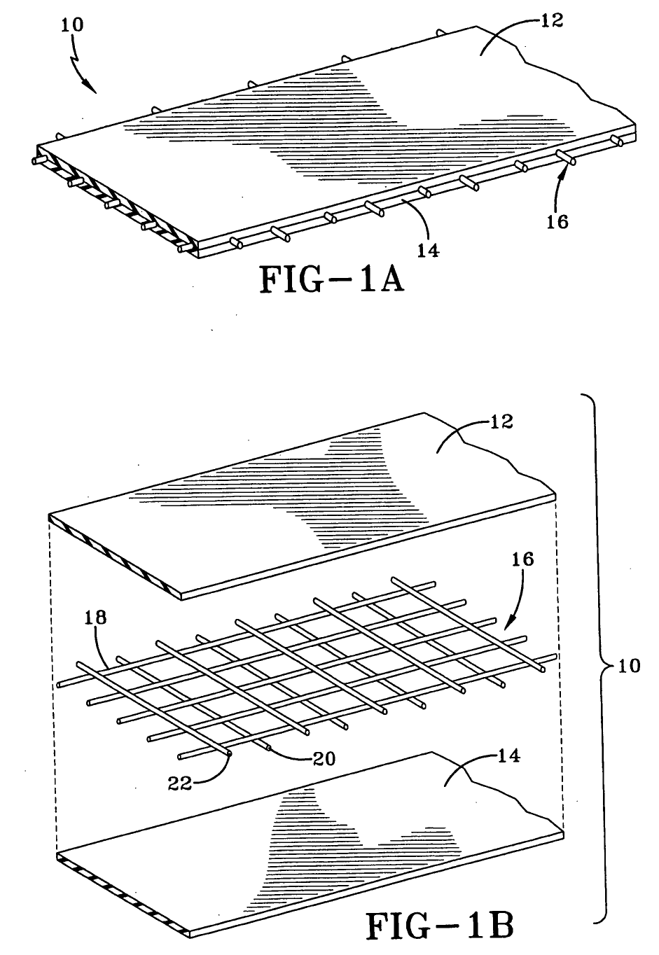

An example of one embodiment of the present invention is shown in FIGS. 1A and 1B, where membrane 10 includes top thermoplastic polymeric layer 12, including a fluorine-containing polymer, a second polymer layer 14, which is substantially devoid of fluoropolymer, and a reinforcing scrim 16 positioned between top layer 12 and bottom layer 14. Layer 12 and layer 14 may be adhered to one another with scrim 16 positioned therebetween by using known techniques such as heat calendaring.

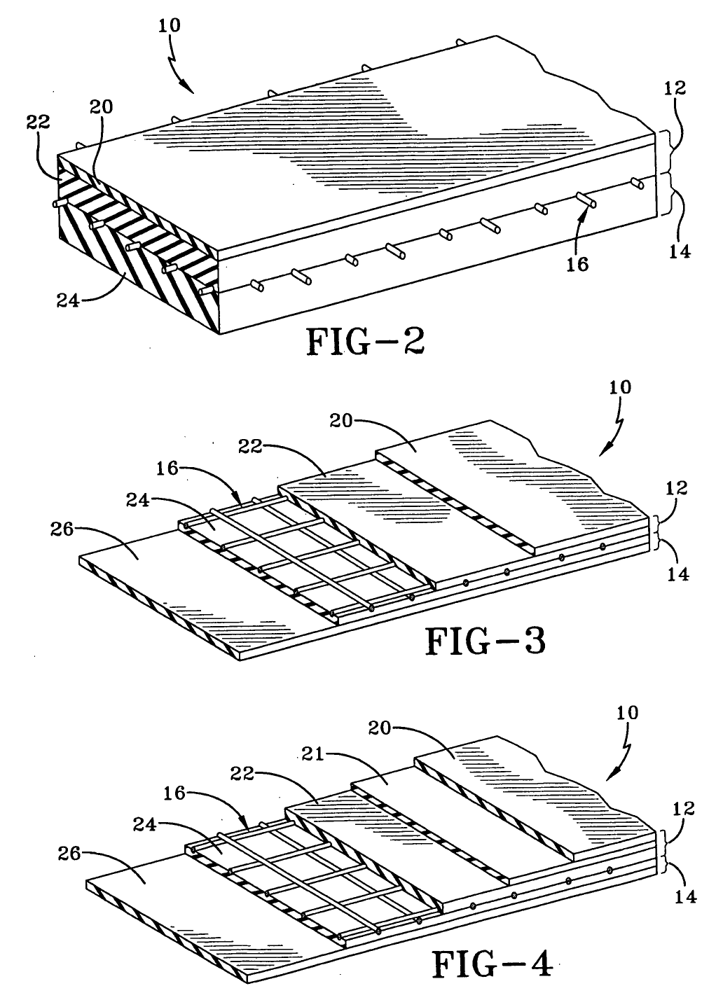

Polymeric layers 12 and 14 may themselves include multiple layers. As a result, membrane 10 may include more than two polymeric layers. For example, and as is shown in FIG. 2, layer 12 includes distinct layers such as cap layer 20 and upper-inner layer 22. These layers may be integrally affixed or intimately bonded to each other such as may occur by co-extrusion methods. Where layers are intimately bonded to form a composite layer, such as 12, the composite layer may be referred to as a bi-layer. Techniques for co-extruding composite layers are disclosed in co-pending U.S. Provisional No. 60/775,128, filed on Feb. 21, 2006, which is incorporated herein by reference. In one or more embodiments, a layer extruded by using co-extrusion techniques may be referred to as a cast film layer. While layers 20 and 22 are intimately bonded, they may nonetheless be distinct layers where layer 20 may include a fluorine-containing polymer and layer 22 may be substantially devoid of fluoropolymer. In other words, membrane 10 may include at least three layers including a first layer including a fluorine-containing polymer, a second layer substantially devoid of fluoropolymer, and third layer substantially devoid of fluoropolymer. In one or more embodiments, layer 22 may be a tie layer that increases the bond strength of cap layer 20 to layer 14. In one or more embodiments, the tie layer may include fluoropolymer, and therefore the membrane depicted in FIG. 2 could have two layers (i.e. both layers of bi-layer 20) including fluoropolymer and one layer (layer 22) that is substantially devoid of fluoropolymer.

In another example, as shown in FIG. 3, both layers 12 and 14 may include bi-layers, where layer 12 includes layers 20 and 22, and layer 14 includes lower-inner layer 24 and bottom layer 26, which may also be referred to as base layer 26. In other words, membrane 10 may include at least four layers including a first layer including a fluorine-containing polymer (e.g. layer 20), a second layer substantially devoid of fluoropolymer (e.g. layer 22), a third layer substantially devoid of fluoropolymer (e.g. layer 24), and fourth layer substantially devoid of fluoropolymer (e.g. layer 26). In one or more embodiments, the inner layers (i.e. layers 22 and 24) may be characterized by a 1% secant modulus, as determined according to ASTM D-7908, of at least 60 mPa, in other embodiments at least 70 mPa, in other embodiments at least 75 mPa, and in other embodiments at least 80 mPa. In these or other embodiments, the 1% secant modulus is less than 200 mPa, in other embodiments less than 150 mPa, and in other embodiments less than 120 mPa. In one or more embodiments, upper-inner layer 22 may be a tie layer. Therefore, in certain embodiments, it may be substantially devoid of fluoropolymer, and in other embodiments it may include fluoropolymer.

With reference again to FIG. 3, the thickness of the overall membrane (i.e. both layers 12 and 14) may vary. In one or more embodiments, the overall thickness may be at least 0.8 mm, in other embodiments at least 1.0 mm, in other embodiments at least 1.2 mm, and in other embodiments at least 1.4 mm. In these or other embodiments, the thickness of the overall membrane is less than 2.5 mm, in other embodiments less than 2.0 mm, in other embodiments less than 1.7 mm, and in other embodiments less than 1.5 mm. The thickness of the membrane above the scrim (i.e. layer 12) as compared to the thickness below the scrim (i.e. layer 14) is substantially the same. In one or more embodiments, any differential in thickness between the layer above the scrim (i.e. layer 12) and the layer below the scrim (i.e. layer 14) is less than 5%, in other embodiments less than 1%, and in other embodiments less than 0.5%. In one or more embodiments, cap layer 20 may have a thickness that is at least 0.125 mm, in other embodiments at least 0.15 mm, in other embodiments at least 0.17 mm, and in other embodiments at least 0.2 mm; in these or other embodiments, the thickness of cap 20 may be less than 0.375 mm, in other embodiments less than 0.30 mm, in other embodiments less than 0.27 mm, and in other embodiments less than 0.25 mm. In one or more embodiments, upper-inner layer 22 may have a thickness that is at least 0.125 mm, in other embodiments at least 0.15 mm, in other embodiments at least 0.17 mm, and in other embodiments at least 0.2 mm; in these or other embodiments, the thickness of upper-inner layer 22 may be less than 0.375 mm, in other embodiments less than 0.30 mm, in other embodiments less than 0.27 mm, and in other embodiments less than 0.25 mm.

In another example, as shown in FIG. 4, layer 12 is a tri-layer and layer 14 is a bi-layer. In other words, layer 12 includes cap layer 20, tie layer 21, and upper-inner layer 22. And, layer 14 includes lower-inner layer 24 and bottom layer 26. In this embodiment, membrane 10 includes at least five layers. Cap layer 20 includes fluoropolymer, and tie layer 21 optionally includes fluoropolymer, and layers 22, 24, and 26 may be substantially devoid of fluoropolymer. As with embodiment shown in FIG. 3, the inner layers surrounding the scrim (i.e. layers 22 and 24) may be characterized by a 1% secant modulus, as determined according to ASTM D-7908, of at least 60 mPa, in other embodiments at least 70 mPa, in other embodiments at least 75 mPa, and in other embodiments at least 80 mPa. In these or other embodiments, the 1% secant modulus is less than 200 mPa, in other embodiments less than 150 mPa, and in other embodiments less than 120 mPa.

With respect to thickness of the various layers, the thickness of cap layer 20 and upper-inner layer 22 may be similar to thickness of the layers of the embodiment shown in FIG. 3. In one or more embodiments, tie layer 21 may have a thickness that is at least 0.025 mm, in other embodiments at least 0.05 mm, in other embodiments at least 0.17 mm, and in other embodiments at least 0.10 mm; in these or other embodiments, the thickness of upper-inner layer 22 may be less than 0.15 mm, in other embodiments less than 0.13 mm, in other embodiments less than 0.12 mm, and in other embodiments less than 0.11 mm.

Practice of the present invention is not necessarily limited by the selection of the reinforcing fabric or scrim. Examples of reinforcing scrims include woven and non-woven scrims, directions and non-directions scrims, and orthogonal and non-orthogonal scrims. Scrims may include a plurality of yarns oriented in the machine direction, or along the length of the scrim, and a plurality of yarns oriented in the cross-machine direction, or across the width of the scrim. These yarns may be referred to as warp yarns and weft yarns, respectively. Practice of the invention is not necessarily limited by the type of yarn employed in the fabric. Exemplary yarns include polyolefin, polyester, polyaramid yarns, and mixtures thereof. Other useful yarns include fiberglass yarns. In one or more embodiments, useful fabrics may include two or more distinct yarns (e.g., both polyester and fiberglass yarns).

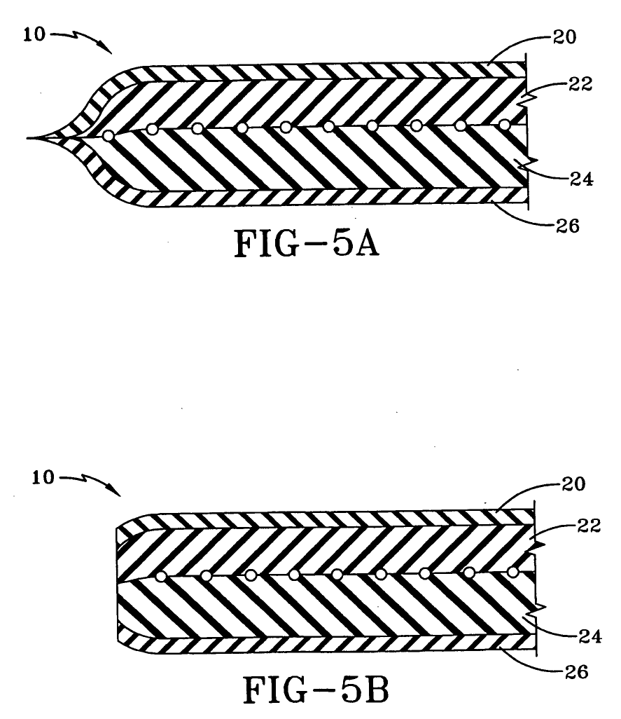

In one or more embodiments, the reinforcing scrim or fabric does not extend across the entire planar width of the fabric. In one or more embodiments, the scrim does not extend to the edge of at least one edge of the membrane. In particular embodiments, the scrim does not extend to the edge of either of the longitudinal edges of the membrane. As a result of this configuration, a gum edge is formed. The gum edge may protect the inner layers of the membranes, which in particular embodiments include polymers more susceptible to deleterious impact from weather and the like. For example, the inner layers may not include UV stabilizers, a therefore a gum edge where the cap layer completely covers the inner layer may be useful. In these or other embodiments, the gum edge may protect the scrim from moisture. In one or more embodiments, the gum edge may be at least 3 mm, in other embodiments at least 5 mm and in other embodiments at least 7 mm; in these or other embodiments, the gum edge may be less than 15 mm, in other embodiments less than 12 mm, and in other embodiments less than 10 mm. An example of a gum edge is shown in FIG. 5A, where cap layer 20 and bottom layer 26 may join to form the gum edge 30. In other embodiments, as shown in FIG. 5B, gum edge 31 may be formed by all four layers.

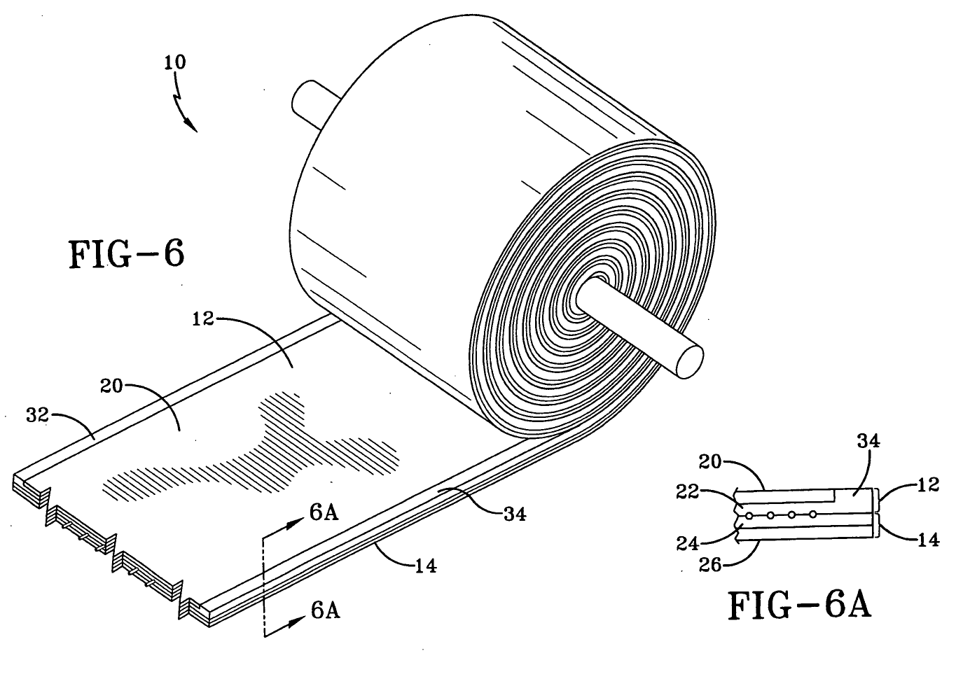

In one or more embodiments, the layer including the fluorine-containing polymer does not extend across the width of the membrane. In particular embodiments, the layer including the fluorine-containing polymer is not present along at least one of the longitudinal edges of the membrane. In certain embodiments, the layer including the fluorine-containing polymer is not present along the both longitudinal edges of the membrane. In one or more embodiments, the absence of the fluorine-containing polymer along the edge of the membrane facilitates heat welding of adjacent membranes. In one or more embodiments, the edge that does not include a layer containing a fluorine-containing polymer may be referred to as a weld edge or seam edge. An example of a membrane including a weld edge according to one or more of these embodiments is shown in FIGS. 6 and 6A, where membrane 10 includes weld edges 32 and 34 along longitudinal edges 33 and 35 respectively. As is shown in FIG. 6A, inner layer 22 may fill the void in the membrane formed by the absence of cap 20 in that area or location. In one or more embodiments, the weld edge is devoid of fluorine-containing polymer. In other embodiments, the weld edge is substantially devoid of fluorine-containing polymer. In one or more embodiments, the width of the weld edge, with respect to the lateral or cross-machine direction of the membrane (i.e. between edges 33 and 35), may be at least 10 cm, in other embodiments at least 12 cm, and in other embodiments at least 15 cm; in these or other embodiments, the width may be less than 30 cm, in other embodiments less than 25 cm, and in other embodiments less than 20 cm.

The fluorine-containing polymer may also be referred to as a fluoropolymer or fluorocarbon polymer. These polymers include homopolymers and copolymers that contain at least one fluorine atom (i.e. one or more fluorine atoms) attached to or tethered to the polymer. The one or more fluorine atoms may be attached directly to a carbon atom of polymer backbone or may be attached to a group or substituent (e.g. ester group) pendent to the polymer backbone. In one or more embodiments, the fluorine-containing polymer includes a fluorine-containing group, which may include a mer unit (i.e. unit of the polymer deriving from polymerization of a particular monomer) or a pendant substituent. In one or more embodiments, the fluorine-containing group includes those groups where at least 25%, in other embodiments at least 50%, in other embodiments at least 75%, and in other embodiments at least 90% of the hydrogen atoms typically bound to the carbon atoms of the group are replaced by a fluorine atom. In one or more embodiments, the group is perfluorinated.

The term polymer is employed in its broadest sense. In one or more embodiments, polymer refers to a macromolecule including at least 3 mer units (i.e. substituent deriving from the polymerization of a monomer), in other embodiments at least 10 mer units, in other embodiments at least 50 mer unit, and in other embodiments at least 100 mer units. In one or more embodiments, at least 25%, in other embodiments at least 50%, in other embodiments at least 75%, in other embodiments at least 90%, and in other embodiments at least 95% of the mer units of the polymer include a fluorine atom. In one or more embodiments, the fluoropolymers employed in the present invention may have a number average molecular weight of at least 5 kg/mol, in other embodiments at least 25 kg/mol, in other embodiments at least 50 kg/mol, in other embodiments at least 100 kg/mol, and in other embodiments at least 125 kg/mol.

In one or more embodiments, the fluoropolymers employed in the practice of these embodiments exhibit at least one melt temperature in the range from about 130° to about 240° C.; in these or other embodiments, the fluoropolymers exhibit a melt temperature of at least 140° C., in other embodiments at least 150° C., and in other embodiments at least 160° C.; in these or other embodiments, the fluoropolymers exhibit a melt temperature of less that 230° C., in other embodiments less than 200° C., and in other embodiments less than 180° C.

In one or more embodiments, the fluoropolymer may include thermoplastic fluoropolymer resins. Examples of thermoplastic fluoropolymers include, without limitation, polytetrafluoroethylene (PTFE), ethylene-tetrafluoroethylene copolymer (ETFE), ethylene-chlorotrifluoroethylene copolymer (ECTFE), polychlorotrifluoroethylene (PCTFE), polyvinylidene fluoride (PVDF), copolymers of PVDF with acrylic resins, polyvinyl fluoride (PVF), fluorinated ethylene propylene (FEP), perfluoroalkoxy resin (PFA), copolymers of fluoroethylene and vinyl ether (FEVE), copolymers of FEVE with acrylic resins, and terpolymers of tetrafluoroethylene, hexafluoropropylene, vinylidene fluoride (THV thermoplastics), copolymer blend of hexafluoropropylene, tetrafluoroethylene and ethylene (THE). Each of these fluoropolymers is known in the art and commercially available from various sources.

ETFEs are melt processable, partially crystalline thermoplastics, and can be processed through normal thermoplastic processing methods including extrusion. Processing temperatures can range from about 550 to 700° F. Commercial types include Aflon™ (AG Fluoropolymers), Halon™ ET (Ausimont), Neoflon™ ET (Daikin), Tefzel™ (DuPont, USA) and Dyneon ETFE™ (Dyneon LLC, USA). In one or more embodiments, an ETFE resin can be extruded into a layer including the fluorine-containing polymer. This layer can be co-extruded with a thermoplastic material including a nonfluorine-containing polymer, or it can be extruded onto a thermoset layer, or optionally onto a tie layer deposited on a thermoset membrane.

ECTFE may likewise be melt processed. Therefore, in a similar fashion to ETFE, an ECTFE resin can be extruded into a layer including the fluorine-containing polymer. This layer can be co-extruded with a thermoplastic material including a nonfluorine-containing polymer, or it can be extruded onto a thermoset layer, or optionally onto a tie layer deposited on a thermoset membrane.

PCTFE may likewise be melt processed. Therefore, in a similar fashion to ETFE, a PCTFE resin can be extruded into a layer including the fluorine-containing polymer. This layer can be co-extruded with a thermoplastic material including a nonfluorine-containing polymer, or it can be extruded onto a thermoset layer, or optionally onto a tie layer deposited on a thermoset membrane.

PVDF may likewise be melt processed. PVDF resins are melt processable, using equipment typically employed for PVC or polyolefins. Extrusion temperatures can vary between 440 to 560° F. Therefore, in a similar fashion to ETFE, a PVDF resin can be extruded into a layer including the fluorine-containing polymer. This layer can be co-extruded with a thermoplastic material including a nonfluorine-containing polymer, or it can be extruded onto a thermoset layer, or optionally onto a tie layer deposited on a thermoset membrane. In one or more embodiments, the PVDF resins include a copolymer of PVDF and CTFE. These copolymers advantageously have lower melt temperatures (e.g., 160° C.-170° C.). Copolymers of PVDF and CTFE are available under the tradename Dyneon™ 31508 and 32008 (3M).

PFAs can be processed into films or sheets through conventional techniques commonly used for thermoplastics, such as extrusion, injection and transfer molding. Although PFAs are melt processable, high processing temperatures, generally above 700° F., are required, due to their high melt viscosity. In one or more embodiments, an extruded PFA film can be laminated.

THVs include terpolymers of tetrafluoroethylene, hexafluoropropylene, and vinylidene fluoride. These resins are processable as thermoplastics and therefore THV resins can be extruded into a layer including the fluorine-containing polymer. This layer can be co-extruded with a thermoplastic material including a nonfluorine-containing polymer, or it can be extruded onto a thermoset layer, or optionally onto a tie layer deposited on a thermoset membrane. THVs are commercially available under the tradename Dyneon™ (3M) such as 220 G, which has a melting temperature of about 120° C., and 500 G, which has a melting temperature of about 165° C.

In one or more embodiments, the layer including the fluorine-containing polymer may include a blend of polymers where the blend includes a fluorine-containing polymer and a polymer that contains no fluorine such as a conventional thermoplastic resin. Examples of polymers that do not include fluorine include those described below, which may be employed in the other layers of the membrane.

In one or more embodiments, the other layers of the laminate membrane may include polymeric materials that are conventionally employed in the art of making thermoplastic roofing membranes. Exemplary thermoplastic membranes or layers include those prepared from polyvinylchloride resins (e.g. PVC) or polyolefin resins (e.g. TPO). These membranes often include stabilizers and/or flame retardants. The use of these materials for roofing membranes is known in the art as described in U.S. Pat. Nos. 6,502,360, 6,743,864, 6,543,199, 5,725,711, 5,516,829, 5,512,118, and 5,486,249, as well as co-pending U.S. Ser. No. 60/712,070, which are incorporated herein by reference.

In one or more embodiments, the thermoplastic polymer includes a polyolefin such as linear low density polyethylene. In these or other embodiments, the layer that is substantially devoid of fluorine-containing polymer may include a blend of polymers as described in co-pending, commonly owned PCT application No. PCT/US2006/033522, filed on Aug. 29, 2006, which is incorporated herein by reference. In one or more embodiments, the layer substantially devoid of fluoropolymer includes a blend of a plastomer, linear low density polyethylene, and a propylene-based copolymer.

In one or more embodiments, tie materials include those materials that can be bonded or will increase the bond between to the layer including the fluorine-containing polymer and the layer that is substantially devoid of fluorine-containing polymer. Examples of tie materials include low-density polyolefins such as low-density polyethylene or low-density polypropylene. In one or more embodiments, the low-density polyolefin may contain polar groups that are pendantly attached to the polymer backbone. In one or more embodiments, these polar groups may derive from carboxylic acids or anhydrides. For example, the polar group may derive from maleic anhydride modified polyolefins are commercially available. In one or more embodiments, these modified polyolefins may include from about 0.09 to about 7 percent by weight maleic anhydride residue, in other embodiments from about 0.1 to about 5 percent by weight maleic anhydride residue, and in other embodiments from about 0.5 to about 2 percent by weight maleic anhydride residue. In another embodiment, the tie layer includes ethylene acrylic acid (EAA), ethylene methacrylic acid (EMA), ethylene vinyl acetate resins, ionomers such as DuPont's Surlyn™ ionomer, or mixtures thereof.

In one or more embodiments, the tie layer may be formed according to techniques described in U.S. Pat. Nos. 6,869,682 and 6,096,428, which are incorporated herein by reference.

The laminate membranes including a thermoplastic fluoropolymer layer may be prepared by employing a variety of techniques. For example, the layer including the fluorine-containing polymer can be extruded separately from the other layers of the membrane, and the individual layers may then be adhered to one another by using techniques such as heat calendaring. In other embodiments, the layer including the fluorine-containing polymer and at least one other layer of the membrane can be co-extruded to form a bi-layer. In one or more embodiments, the b0-layer may be bonded to yet another layer or bi-layer by employing techniques such as heat calendaring.

In the following set of embodiments, the layer including fluoropolymer of the membranes of the present invention is a coating layer. In other words, the membranes include a coating including a fluorine-containing polymer or crosslink thereof.

In one or more embodiments, the overall membrane thickness of the membranes of these embodiments (including coating) may be from about 0.5 to about 2.5 mm, in other embodiments from about 1.0 to about 2.0 mm, and in other embodiments from about 1.2 to about 1.7 mm. In these or other embodiments, the overall thickness of the membrane (including the coating) may be at least 0.5 mm, in other embodiments at least 1.0 mm, and in other embodiments at least 1.2 mm. In these or other embodiments, the overall thickness of the membrane may be less than 2.0 mm, in other embodiments less than 1.7 mm, and in other embodiments less than 1.5 mm.

In one or more embodiments, the coating including the fluorine-containing polymer may include a dried film of a coating composition that includes a fluorine-containing polymer. In one or more embodiments, the dried film or coating may also be referred to as a fluorine-containing polymeric layer or a fluoropolymer layer.

In one or more embodiments, the dried film thickness of the coating or layer containing the fluorine-containing polymer may be from about 0.01 to about 0.1 mm, in other embodiments from about 0.02 to about 0.07 mm, in other embodiments from about 0.025 to about 0.05, and in other embodiments from about 0.03 to about 0.04 mm. In these or other embodiments, the dried film thickness may be less than 0.4 mm, in other embodiments less than 0.3 mm, in other embodiment less than 0.2 mm, in other embodiments less than 0.1 mm, in other embodiments less than 0.07 mm, and in other embodiments less than 0.05 mm. In these or other embodiments, the dried film thickness may be at least 0.02 mm, in other embodiments at least 0.03 mm, in other embodiments at least 0.04 mm, and in other embodiments at least 0.05 mm.

In one or more embodiments, the coating is disposed on a membrane, which may be referred to as a membrane substrate. In one or more embodiments, the coating or film may be bonded or adhered to the membrane substrate. For example, the bonding between the coating and the membrane substrate may occur by chemical reaction including covalent, ionic, hydrogen, or van der waals bonding. In these or other embodiments, the bonding may be mechanical in nature whereby the coating intermingles or intertwines with the surface of the membrane substrate.

In one or more embodiments, the fluorine-containing polymer may be referred to as a fluoropolymer. In one or more embodiments, the fluorine-containing polymer includes homopolymers and/or copolymers that contain at least one fluorine atom (i.e. one or more fluorine atoms) attached to or tethered to the polymer. In one or more embodiments, the one or more fluorine atoms may be attached directly to a carbon atom of polymer backbone. In these or other embodiments, the one or more fluorine atoms may be attached to a group or substituent (e.g. ester group) pendent to the polymer backbone. In one or more embodiments, the fluorine-containing polymer includes a fluorine-containing group, which may include a mer unit (i.e. unit of the polymer deriving from polymerization of a particular monomer) or a pendant substituent. In one or more embodiments, the fluorine-containing group includes those groups where at least 25%, in other embodiments at least 50%, in other embodiments at least 75%, and in other embodiments at least 90% of the hydrogen atoms typically bound to the carbon atoms of the group are replaced by a fluorine atom. In one or more embodiments, the group is perfluorinated.

The term polymer is employed in its broadest sense. In one or more embodiments, polymer refers to a macromolecule including at least 3 mer units (i.e. substituent deriving from the polymerization of a monomer), in other embodiments at least 10 mer units, in other embodiments at least 50 mer unit, and in other embodiments at least 100 mer units. In one or more embodiments, at least 25%, in other embodiments at least 50%, in other embodiments at least 75%, in other embodiments at least 90%, and in other embodiments at least 95% of the mer units of the polymer include a fluorine atom. In one or more embodiments, the fluoropolymers employed in the present invention may have a number average molecular weight of at least 5 kg/mol, in other embodiments at least 25 kg/mol, in other embodiments at least 50 kg/mol, in other embodiments at least 100 kg/mol, and in other embodiments at least 125 kg/mol.

In one or more embodiments, the fluoropolymer may include thermoplastic fluoropolymer resins, fluoropolymer thermosetting resins, or mixtures thereof. Where the fluoropolymer employed is a thermosetting resin and fluoropolymer is crosslinked or cured (i.e. set) as it exists in the membrane, the fluoropolymer may be referred to as a cured, crosslinked, or thermoset fluoropolymer.

Fluoropolymers may include, without limitation, polytetrafluoroethylene (PTFE), ethylene-tetrafluoroethylene copolymer (ETFE), ethylene-chlorotrifluoroethylene copolymer (ECTFE), polychlorotrifluoroethylene (PCTFE), polyvinylidene fluoride (PVDF), copolymers of PVDF with acrylic resins, polyvinyl fluoride (PVF), fluorinated ethylene propylene (FEP), perfluoroalkoxy resin (PFA), copolymers of fluoroethylene and vinyl ether (FEVE), copolymers of FEVE with acrylic resins, and terpolymers of tetrafluoroethylene, hexafluoropropylene and vinylidene fluoride (THV thermoplastics). Each of these fluoropolymers is known in the art and commercially available from various sources.

The membrane substrate on which the coating is disposed may include a polymeric membrane. The polymeric membrane may include a thermoplastic membrane, a thermoset membrane, or a mixture thereof. In one or more embodiments, the membrane substrate may include a single ply membrane or a multi-ply membrane, which may also be referred to as a multi-layered membrane. In these or other embodiments, the membrane substrate may include a reinforcing scrim or fabric.

In one or more embodiments, the membrane substrate includes limited or no fluorine-containing polymer. In one or more embodiments, the membrane substrate is devoid or substantially devoid of a fluorine-containing polymer. Substantially devoid refers to that amount or less of fluoropolymer that will not have an appreciable impact on the properties of the layer. In one or more embodiments, the membrane substrate includes less than 5 weight %, in other embodiments less than 1 weight %, in other embodiments less than 0.5 weight %, and in other embodiments less than 0.1 weight % of a fluorine-containing polymer based on the total polymeric content of the membrane substrate. In one or more embodiments, where the membrane substrate is multi-layered, at least one layer of the multi-layered membrane substrate is devoid or substantially devoid of fluorine-containing polymer.

In one or more embodiments, the reinforcing scrims include woven and non-woven scrims, directions and non-directions scrims, and orthogonal and non-orthogonal scrims. Scrims may include a plurality of yarns oriented in the machine direction, or along the length of the scrim, and a plurality of yarns oriented in the cross-machine direction, or across the width of the scrim. These yarns may be referred to as warp yarns and weft yarns, respectively. Practice of the invention is not necessarily limited by the type of yarn employed in the fabric. Exemplary yarns include polyolefin, polyester, polyaramid yarns, and mixtures thereof. Other useful yarns include fiberglass yarns. In one or more embodiments, useful fabrics may include two or more distinct yarns (e.g., both polyester and fiberglass yarns).

In one or more embodiments, the membrane substrate may include thermoplastic polymers such as polyvinylchloride resins (e.g. PVC) or polyolefin resins (e.g. TPO). These membranes often include stabilizers and/or flame retardants. The use of these materials for roofing membranes is known in the art as described in U.S. Pat. Nos. 6,502,360, 6,743,864, 6,543,199, 5,725,711, 5,516,829, 5,512,118, and 5,486,249, as well as co-pending U.S. Ser. No. 60/712,070, which are incorporated herein by reference.

In other embodiments, the membrane substrate may include thermoset polymers such as poly(ethylene-co-propylene-co-diene) terpolymer rubber or poly(ethylene-co-propylene) copolymer rubber or crosslinked derivatives thereof, which may be referred to as EPDM or EPM membranes. These membranes include those defined meeting the performance specifications provided in ASTM-D-1418-85 and/or ASTM-4637-03. EPDM membranes may be cured by using a curative in the formulation, optionally in conjunction with various accelerators, the combination of which is often referred to as a cure package. These membranes may also include extender oils, processing aids such as various metal salts of stearic acid, sodium dodecyl sulfate as well as tackifying resins, plasticizers, antioxidants, antiozonants, waxes, cure accelerators, zinc oxide, stearic acid, UV stabilizers, and the like, all in conventional amounts as known. Roofing membranes made from these materials are described in U.S. Pat. Nos. 6,632,509, 6,615,892, 5,700,538, 5703,154, 5,804,661, 5,854,327, 5,093,206, and 5,468,550, which are incorporated herein by reference.

An example of a membrane according to these embodiments is shown in FIG. 7, where membrane 60 includes membrane substrate 64, coating 62, and scrim 66.

In one or more embodiments, the coated membranes of the present invention are prepared by applying a coating composition to a membrane. In one or more embodiments, upon curing or drying, the coating composition forms the coating including the fluoropolymer.

The membrane substrate can be prepared by a variety of techniques known in the art. For example, where the membrane substrate includes a thermoset (e.g. EPDM), the thermoset can be prepared by employing conventional techniques such as extrusion, calendaring, and curing. In one or more embodiments, the coating composition including the fluoropolymer may be applied before the membrane is set (i.e. cured). In other embodiments, the coating composition can be applied to a green rubber sheet (e.g., uncured EPDM), and then the green rubber is subsequently cured.

Application of the coating composition to the membrane substrate can occur by employing a variety of techniques. For example, the coating composition can be applied by spraying, brushing, rolling, flood coating and/or knife coating. In one or more embodiments, application of the coating to the membrane can occur within a factory or other controlled setting such as where the membrane substrate is manufactured. In other embodiments, the coating can be applied to the membrane after the membrane is installed to a roof, which may be referred to as field application.

In one or more embodiments, the fluoropolymer layer may be applied to a primer layer or tie layer that can be applied to the substrate (e.g. EPDM). The primer layer functions by increasing the bond between the coating and the membrane substrate. The tie layer may be formed according to techniques described in U.S. Pat. Nos. 6,869,682 and 6,096,428, which are incorporated herein by reference. In one or more embodiments, the primer can be applied as a solution, suspension, latex. Application of the primer can take place by spraying, rolling, flood coating, and/or knife coating the primer onto the membrane. Useful primers may include, for example, phosphine compounds. Useful compounds and techniques are described in THE INTERNATIONAL JOURNAL OF ADHESION AND ADHESIVES, Volume 15, page 87, by Brewis et al. (1995), JOURNAL OF ADHESION, Volume 40, page 81 (1993), and Journal of Applied Polymer Science, volume 48(2), page 359 (1993). In one or more embodiments, the tie layer includes a dried film of a primer or tie layer composition. The thickness of the tie layer dried film may be at may be less than 0.1 mm, in other embodiments less than 0.07 mm, and in other embodiments less than 0.05 mm. In these or other embodiments, the dried film thickness may be at least 0.009 mm, in other embodiments at least 0.01 mm, and in other embodiments at least 0.03 mm.

In other embodiments, the surface of the cured rubber membrane can optionally be treated to improve the adhesion of the coating to the rubber.

In one or more embodiments, the coating composition includes a fluorine-containing polymer and a solvent or carrier. For example, the fluoropolymer may be dissolved in the solvent, which may include a variety of organic solvents. Those skilled in the art will be able to readily select an appropriate organic solvent based upon solubility parameters and the fluoropolymer of choice. In other embodiments, the composition is a latex. For example, the fluoropolymer may be suspended or emulsified in an aqueous medium.

In one or more embodiments, solvent soluble copolymers of fluoroethylene and vinyl ether (FEVE) may be employed as the fluoropolymer. FEVEs fluoropolymers include alternating mer units deriving from fluoroethylene and/or chlorofluorethylene (CTFE), and vinyl ether monomer. The fluoroethylene mer units may provide good weatherability properties and the mer vinyl ether units may provide flexibility, solvent solubility, and processability. The vinyl ether mer units can be chosen to have functionalities that will affect other properties, such as solubility, flexibility, processability, crosslinkability, and adhesiveness. In one or more embodiments, the mer units can be chosen to achieve an emulsifiable polymer. For example, hydroxyl-alkylvinyl ethers could be employed to provide an FEVE copolymer that can be crosslinked with curing agents such as isocyanates and melamines. FEVEs are commercially available under the tradenames Lumiflon™ LF-200F from companies such as Asahi Glass Co. Ltd. (Japan). In one or more embodiments, the FEVEs may be dissolved in aromatic solvents such as xylene, or in polar solvents such as ethers and/or ketones.

In one or more embodiments, useful FEVEs include those defined by the formula

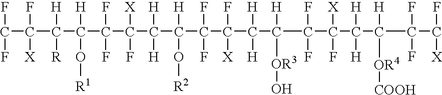

wherein X is F or Cl, with the understanding, as set forth above, that this invention includes a fluoropolymer having at least one fluorine atom bound to a carbon atom of the polymer; R1 and R2 are alkyl groups; and R3 and R4 are alkylene groups.

Water-borne FEVEs may also be employed. As those skilled in the art appreciate, the ability to form water-borne coating compositions with these copolymers can be controlled by tailoring the functional unit on the vinyl monomer. For example, the presence of carboxylic acid functionalities can provide the ability to form a water-borne system. These water borne copolymers may be crosslinked with water-borne isocyanates. Also, these water borne systems may include other polymer or monomer including those conventionally employed in coating industry. For example, the water-borne coating system may include from about 20 to about 60, and in other embodiments from about 30 to about 50, percent by weight acrylic monomer. These water-borne FEVEs are commercially available from companies such as Asahi Class Co. Ltd. (Japan) under the tradenames Lumiflon™ FE-4300.

Mixtures of PVDF and acrylic resin (either in solvent or latex form) may also be employed as a coating composition. Depending on the nature of the composition, particularly where the blend in solvent borne, curing of the coating may require high temperature treatment or baking. These compositions are commercially available under the tradenames Kynar™ (Arkema). Other commercially available compositions include RC-10147™ AMF Latex (Aquatec).

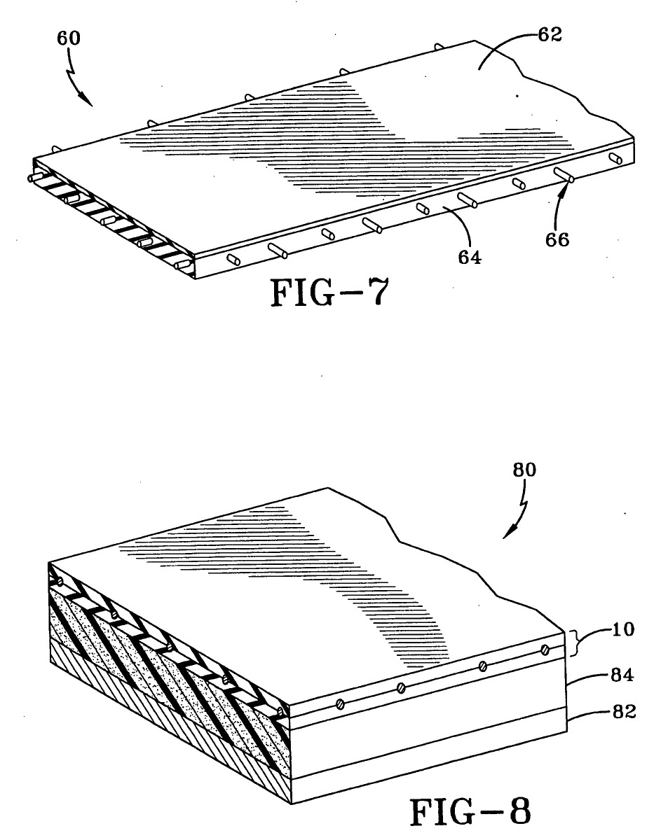

In one or more embodiments, the membranes of this invention, including those with at thermoplastic fluoropolymer layer or a fluoropolymer layer deriving from a coating composition, may be employed as a roofing membrane. These membranes may be included within a roofing system, which may include a roof deck, an optional insulation layer, and a roofing membrane. For example, FIG. 8 depicts a roofing system 80 including a roof deck 82, an optional insulation layer 84, and a roofing membrane 10 according to one or more embodiments of the present invention.

Practice of this invention is not limited by the selection of any particular roof deck. Accordingly, the roofing systems herein can include a variety of roof decks. Exemplary roof decks include concrete pads, steel decks, wood beams, and foamed concrete decks.

Practice of this invention is likewise not limited by the selection of any particular insulation board, and, indeed, this invention is disclosed without reference to insulation boards, their use being optional. To the extent that it would be desired to employ an insulation board in a roofing system of this invention, the manner of its incorporation into the system will be readily apparent to those of ordinary skill in the art. As is known in the art, several insulation materials can be employed, including polyurethane or polyisocyanurate cellular material. These insulation boards are known in the art as disclosed in U.S. Pat. Nos. 6,117,375, 6,044,604, 5,891,563, 5,573,092, U.S. Publication Nos. 2004/01099832003/0082365, 2003/0153656, 2003/0032351, and 2002/0013379, as well as U.S. Ser. Nos. 10/640,895, 10/925,654, and 10/632,343, which are incorporated herein by reference.

Depending on the nature of the membrane, the application methods employed to secure the membranes to the roof may vary. For example, where the membranes include a thermoset resin such as EPDM, it is conventional to mechanically fasten or employ an adhesive to secure the membrane to the roof surface. A seam is typically formed between various membranes by application of a seam tape.

Inasmuch as the membranes of the present invention include a fluorine-containing layer, which is typically positioned on the top of the membrane (i.e., the surface of the membrane directly exposed to the environment), it may be desirable to treat the fluorine-containing layer at a location where the lap seam is desired (i.e., at a location where the seam tape will be applied).

The membranes of the present invention can be used in a conventional manner to cover roofing surfaces. As described above, they may be used to form roofing systems that include a roof deck, an optional insulation layer, and a roofing membrane, as well as any other constituents of a roofing system as known in the art.

In one or more embodiments where the membrane is a thermoplastic, two or more membranes can be joined by heat welding the membranes together. In other embodiments, adjacent membranes can be secured to each other by using fastening means such as liquid or solid adhesives.

Inasmuch as the membranes of the present invention include a fluorine-containing layer, which is typically positioned on the top of the membrane (i.e., the surface of the membrane directly exposed to the environment), it may be desirable to treat the fluorine-containing layer at a location where the lap seam is desired (i.e., at a location where the seam tape will be applied) or a the location where the heat weld is formed.

In one or more embodiments, the fluorine-containing layer can be etched away by using procedures and/or etching materials known in the art. For example, sodium compositions may be employed to etch away the fluorine-containing layer, thereby allowing the seam tape to adhere to the non-fluorine containing layer.

In other embodiments, it may also be useful to prepare the membranes of the present invention with a lap seam area. In other words, a portion of the membrane along one or more edges maybe devoid or essentially devoid of a fluorine-containing layer. Several manufacturing techniques can be employed to achieve this seam area such as protecting the surface of the membrane with a releasable tape prior to application of a fluorine-containing coating composition. Where the fluorine-containing layer is formed by extrusion, the die from which the fluorine-containing layer is extruded can be adjusted so as to form a fluorine-containing layer over only a portion of the non-fluorine-containing layer (i.e., extrusion of the fluorine-containing layer will not occur in the lap seam area).

In other embodiments, the membranes of the present invention may be employed as geo membranes such as, but not limited to, pond liners. In other embodiments, the membranes of the present invention can be employed to fabricate walkway pads.

Various modifications and alterations that do not depart from the scope and spirit of this invention will become apparent to those skilled in the art. This invention is not to be duly limited to the illustrative embodiments set forth herein.

What is claimed is:

1. A membrane comprising:
at least two distinct polymeric layers, where one layer includes a fluorine-containing polymer.

2. The membrane of claim 1, where one layer is substantially devoid of fluorine-containing polymer.

3. The membrane of claim 1, where the fluorine-containing polymer is a thermoplastic.

4. The membrane of claim 1, where the fluorine-containing polymer is a thermoset.

5. The membrane of claim 3, where the one layer including a fluorine-containing polymer is formed by extrusion of a thermoplastic.

6. The membrane of claim 4, where the one layer including a fluorine-containing polymer is formed by the application of a coating composition.

7. The membrane of claim 1, where the fluorine-containing polymer includes a group where at least 50% of the of the hydrogen atoms of the group are replaced by fluorine.

8. The membrane of claim 1, where at least 50% of the mer units of the fluorine-containing polymer include fluorine.

9. A multi-layered thermoplastic membrane comprising:
a first layer including a thermoplastic fluorine-containing polymer; and
a second layer that is distinct from the first layer.

10. The membrane of claim 9, where the first layer includes at least 10 weight % fluorine-containing polymer based upon the total weight of the polymeric content of the layer, and where the second layer includes less than 5 weight % fluorine-containing polymer based upon the total weight of the polymeric content of the layer.

11. The membrane of claim 9, where the multi-layered thermoplastic membrane includes at least three layers.

12. The membrane of claim 9, where the multi-layered thermoplastic membrane includes at least four layers.

13. The membrane of claim 9, where the multi-layered thermoplastic membrane includes five layers and a scrim, where a top layer includes the fluorine-containing polymer, a tie layer adjacent to the top layer that includes a tie material, and where the second layer adjacent to the tie layer but opposite to the top layer and is substantially devoid of fluorine-containing polymer.

14. The membrane of claim 13, where the overall thickness of the membrane is at least 0.8 mm and less than 2.5 mm, where the thickness of the top layer is at least 0.125 mm and less than 0.375 mm, where the thickness of the tie layer is at least 0.025 mm and less than 0.15 mm.

15. The membrane of claim 14, where the overall thickness of the membrane is at least 1.0 mm and less than 2.0 mm, where the thickness of the top layer is at least 0.15 mm and less than 0.30 mm, where the thickness of the tie layer is at least 0.05 mm and less than 0.13 mm.

16. The membrane of claim 15, where the scrim is positioned substantially in the center of the membrane with respect to the thickness of the membrane.

17. The membrane of claim 16, where the scrim is positioned such that the any differential in the thickness of the membrane above and below the scrim is less than 5%.

18. The membrane of claim 13, where the top layer, the tie layer, and the second layer are coextruded.

19. The membrane of claim 17, where the membrane includes two distinct layer below the scrim.

20. The membrane of claim 9, where the membrane includes a gum edge.

21. The membrane of claim 9, where the membrane includes a weld edge that is substantially devoid of fluorine-containing polymer.

22. A membrane including a coating, the membrane comprising:
a membrane substrate; and
a coating disposed on the substrate, where the coating includes a fluorine-containing polymer.

23. The membrane of claim 22, where the coating includes a dried film of a coating composition including a fluorine-containing polymer.

24. The membrane of claim 23, where the thickness of the dried coating is at least 0.009 mm and less than 0.1 mm.

25. The membrane of claim 23, where the thickness of the dried coating is at least 0.01 mm and less than 0.07 mm.

26. The membrane of claim 22, where the overall thickness of the membrane is from about 0.5 mm to about 2.5 mm.

27. The membrane of claim 22, where the membrane substrate is a thermoset material.

28. The membrane of claim 27, where the membrane includes a cured ethylene-propylene-diene rubber.

29. The membrane of claim 27, where the membrane substrate is a vulcanizate of a terpolymer of ethylene, propylene, and diene.

30. A method of treating a roofing membrane, the method comprising coating the roofing membrane with a composition including a fluorine-containing polymer.

31. A co-extruded membrane comprising at least one cast film that includes a fluorine-containing thermoplastic polymer.

32. A polymeric membrane coated with a composition including a fluorine-containing polymer.

33. A polymeric membrane substantially as hereinbefore described with reference to any one of FIGS. 1 to 8.

33. A roofing system comprising:
(i) a roof deck;
(ii) an optional insulation layer; and
(ii) a membrane, where the membrane includes at least two distinct layers, and where one layer includes a fluorine-containing polymer.
